(19) United States
(12) Patent Application Publication
(10) Pub. No.: US 2026/0179372 A1
(43) Pub. Date: Jun. 25, 2026

(54) SPARSE CODING AND EXTRACTION OF ULTRASOUND KNOWLEDGE FOR EXPLAINABLE POINT-OF-CARE ULTRASOUND ARTIFICIAL INTELLIGENCE

(71) Applicant: Drexel University, Philadelphia, PA (US)

(72) Inventors: Christopher J. MacLellan, San Antonio, TX (US); Rosina O. Weber, Wilmington, DE (US); Edward Kim, Wynnewood, PA (US); Darryl Hannan, San Antonio, TX (US); Steven C. Nesbit, Philadelphia, PA (US); Qiao Zhang, Bayonne, NJ (US); Glen Smith, Philadelphia, PA (US); Alberto Goffi, Toronto (CA); Vincent Chan, Toronto (CA); Ximing Wen, Philadelphia, PA (US)

(73) Assignee: Drexel University, Philadelphia, PA (US)

(21) Appl. No.: 19/124,912

(22) PCT Filed: Oct. 28, 2023
(86) PCT No.: PCT/US2023/078130

§ 371 Date: Apr. 28, 2025

Related U.S. Application Data
(60) Provisional application No. 63/381,678, filed on Oct. 31, 2022.

(51) Int. Cl. G06V 10/82

(52) U.S. Cl. CPC G06V 10/82

(57) ABSTRACT

A system develops classifiers that can aid medical professionals by diagnosing whether or not a patient has a medical condition like pneumothorax. The system breaks the task into multiple steps, using YOLOv4 to extract relevant regions of the video and a 3D sparse coding model to represent video features. Given the difficulty in acquiring positive training videos, the inventors trained a small-data classifier with a maximum of 15 positive and 32 negative examples. To counteract this limitation, the inventors leveraged subject matter expert (SME) knowledge to limit the hypothesis space, thus reducing the cost of data collection. The inventors present results using two lung ultrasound datasets and demonstrate that the inventors' model is capable of achieving performance on par with SMEs in pneumothorax identification.

### STATEMENT REGARDING GOVERNMENT SUPPORT

This invention was made with government support under Contract No. HR00112190076 awarded by the Defense Advanced Research Projects Agency. The government has certain rights in the invention.

### BACKGROUND

Ultrasound imaging techniques are crucial to many medical procedures and examinations. The development of portable ultrasound devices has allowed healthcare professionals to perform and interpret sonographic examinations with the goal of making immediate patient care decisions wherever a patient is being treated, including out-of-hospital scenarios. This clinician-performed and -interpreted ultrasonography at the patient's bedside has been referred to as Point-of-Care Ultrasound (POCUS). While POCUS allows ultrasound to be used in a variety of new tasks and settings, a few bottlenecks remain. For example, both the acquisition and interpretation of sonograms requires specific training and competency development. Moreover, the quality of the ultrasound device and the proficiency of the operator collecting the data can lead to challenging cases that are uninterpretable or elicit disagreement among experts.

The development of AI systems that can assist medical professionals in interpreting sonograms by highlighting key regions of interest (ROIs) and suggesting potential diagnoses would increase both the accuracy and the efficiency of differential diagnosis. However, developing intelligent systems that can operate in the medical domain is challenging due to the lack of annotated data. Many computer vision applications rely upon thousands, or even millions, of examples to achieve reasonable performance. In the medical domain, collecting labels is an expensive process because a high degree of expertise is required to interpret the images. Additionally, data collection for some tasks can be challenging due to some procedures only being performed in specific high-stakes situations (e.g., the patient's life might be at risk and immediate action is required). In the domain of real-world images, transfer learning techniques are frequently used to compensate for a lack of labeled data, however they are suboptimal for the medical domain due to a lack of visual feature overlap. You can see this at https://arxiv.org/abs/1902.07208.

Due to the COVID-19 pandemic, lung ultrasound (LUS) has received heightened attention by the machine learning community. There are two commonly used public datasets targeting this task, the ICLUS-DB and the COVID-19 dataset. The most common LUS task formulation is frame classification and semantic segmentation, with some papers including video classification as well. Many works rely upon a convolutional neural network (CNN)-based architecture for feature extraction, then aggregate frame scores for a video-level prediction. Some works extend this by adding a temporal component to the model, allowing it to detect changes in the video over time. One approach opted for a 3D CNN with a separate optical flow branch for capturing these dependencies. Some work has sought to explicitly leverage expert annotations to improve performance. Another approach used a convolutional network with not only the B-mode frame as input but also a vertical artifact mask and pleural line heatmap. Finally, a recent solution took an approach more similar to the one herein, where instead of classifying the whole video, the model only classifies an ROI centered on the pleural line. They determined the ROI by automatically selecting the highest peak in a Radon transformation, whereas in the solution described herein, the inventors used a separately trained object detection model.

### SUMMARY OF THE EMBODIMENTS

The inventors propose a POCUS mobile application within the context of an ultrasound video classification task. Given an LUS video, the application must classify it according to whether the symptoms of pneumothorax (PTX) are present or not. Before constructing the system, the inventors sought to gain insight into the process that experts use to make their diagnoses and inject this information into the inventors' architecture. Prior work conducted a think aloud analysis where two subject matter experts (SMEs) analyzed and diagnosed videos of patients that potentially had PTX. From these studies, the pleural line (where the lung comes into contact with the chest wall) and its movement, were determined to be the most important features.

In a normal lung, two types of movement of the pleural line can be observed: lung sliding (shimmering movement synchronous with respirations) and lung pulse (rhythmic movement of the pleural line at the cardiac frequency). In a patient with PTX, the pleural line remains relatively stationary, displaying no sliding and no pulse. FIG. 1.1 shows a still image from an LUS with the pleural line highlighted.

The inventors leveraged this expert knowledge in the inventors' pipeline by decomposing the task into three stages. The first stage extracts the pleural line from the video. The second stage uses a 3D sparse coding model to extract a sparse representation of the pleural line clip. The sparse coding model contains biologically inspired mechanisms, such as lateral inhibition, that produce high quality representations with orthogonal features. This model also operates over multiple frames, capturing movement in the video. The final stage passes the sparse representation to a small convolutional neural network (CNN) classifier.

Due to the difficulties surrounding collection and labeling of medical images, the inventors focused on developing a highly accurate PTX model using only a small number of labeled videos. In the inventors' primary benchmark, the inventors used just 47 LUS videos, each approximately 3 seconds long, and trained the inventors' model from scratch. To complement the portability of POCUS devices, the inventors ensured that the inventors' mobile application can execute on portable, relatively inexpensive hardware. For the inventors' experiments, the inventors selected a 12.9-inch Apple ipad Pro as the inventors' target device and developed the inventors' application for iOS 15.

The inventors demonstrate that the application can perform on par with SMEs and that it outperforms a comparable variational autoencoder (VAE)-based architecture and Mini-COVIDNet on PTX and COVID-19 datasets. The inventors then analyzed the impact of further restricting training data, illustrating the inventors' model's robustness to learning from limited examples, and evaluated the inventors' model in a transfer learning setting where features are trained on one task and applied to another, demonstrating the importance of the inventors' sparse filters. The inventors qualitatively analyzed the inventors' learned filters and discuss efforts aimed at interpretability. Lastly, the inventors provide an overview of the inventors' mobile implementation and various challenges that need to be addressed for the inventors' application to be deployed.

This work is more application driven than most prior scholarly works; the inventors learned with limited data and ran the inventors' model on a mobile device. Earlier work trained a frame-based classification model based upon MobileNet on just 1,103 ultrasound images. They then demonstrated that their model was able to run on two different embedded systems. One major difference between their work and the inventors' own is that the inventors focused on video-level classification and handled temporal information by processing video clips instead of image frames. This places a larger burden on the model, making it more difficult to execute on a mobile device. Another difference is that the inventors leveraged expert knowledge expressed in a think aloud analysis to construct the inventors' pipeline. This leads to a greater degree of interpretability in the form of an ROI bounding box around the pleural line.

This work also describes an approach for constructing task-specific machine learning models. This approach emphasizes integrating interpretability into the model development process, leveraging domain-specific subject matter expert (SME) knowledge to construct machine learning pipelines that not only perform well but also surface relevant information about the model. While at a high-level the proposed paradigm could be applied to any domain, the inventors focus on the medical domain where model safety is especially relevant. In the medical domain, it's crucial that models are transparent and augment care, addressing the needs of medical professionals to better support their decision making.

More specifically, the inventors present a framework for developing medical imaging applications in the context of an ultrasound video classification task. This framework is designed to be applied individually to each target task. It consists of 4 phases: 1) connecting with subject matter experts (SMEs) and obtaining a high-level understanding of the task, 2) decomposing the task into phases, 3) selecting model components for each step, and 4) training and evaluating the models. The framework focuses on interpretability in the form of visualizable feedback that can be directly provided to the examiner to augment their decision making. This is accomplished not through specialized modeling components or post-hoc gradient-based explainability methods but is instead a natural consequence of the framework itself. Expert guided task decomposition results in intermediate outputs that are closely aligned with the interpretation process employed by a human. The inventors hope that future work can leverage the framework to develop additional ultrasound imaging applications.

We apply the proposed framework to an ultrasound video classification task, optic nerve sheath diameter (ONSD) measurement. This is a procedure that is commonly conducted for the identification, monitoring, and management of elevated intracranial pressure (ICP) in patients with several neurological conditions, especially traumatic brain injury (TBI). The inventors are the first work to address this challenging measurement task at the video level. The inventors detail two approaches: a 2D convolutional LCA sparse coding model inspired by the work of Hannan et al. (2023) and a R2U-Netbased model (Alom et al. 2018) that directly predicts the width of the nerve by generating a mask at the point of measurement (FIG. 1). The former was developed after an initial application of the framework, while the latter was the result of further iteration, resulting in a system that is more interpretable and directly supports the diagnostic procedure.

We conduct a full set of experiments for both models, comparing them to CLIP ViT-B/16 (Radford et al. 2021) and ConvNeXT (Liu et al. 2022), two pre-trained models that are exposed to millions of examples during pre-training. The inventors demonstrate that the proposed models outperform each of these architectures, despite no pre-training, with the R2UNet approach exceeding the other models by a large margin. The inventors also conduct a qualitative analysis of this model where a SME assessed its generated predictions. The inventors conclude by discussing the interpretability of the system, highlighting how its outputs can be used to augment care.

In summary, this disclosure makes the following disclosures:
an LUS video classification framework based upon features that experts identified as important in diagnosing PTX;
the framework outperforms existing architectures and achieves accuracy on par with SMEs, despite only being exposed to a few dozen labeled videos; and
an iOS application that executes the inventors' model in just a few seconds, illustrating that the framework can be deployed in a wide range of settings at low cost.

### BRIEF DESCRIPTION OF THE DRAWINGS

FIG. 1.1: Sample lung sonogram from the COVID-19 dataset, highlighting the pleural line.

FIG. 1.2: Overview of the PTX Classification Architecture.

FIG. 1.3: Macro F1 score of the model with varying quantities of positive training examples.

FIGS. 1.4(a) and 1.4(b): First frame of the filters learned by the 3D sparse coding model compared with the VAE baseline.

FIG. 1.5: Screenshot of the iOS application running on a 12.9-inch Apple iPad Pro.

FIG. 1.6 shows Table 1.1: F1 scores (over 5 runs) for the BAMC dataset.

FIG. 1.7 shows Table 1.2: F1 scores (over 3 runs) for the COVID-19 dataset.

FIG. 1.8 shows Table 1.3: Results for the Brooke Army Medical Center (BAMC) PTX dataset using 3 different methods for building the sparse filters.

FIG. 2.1 shows output from the R2U-Net-based interpretable ONSD measurement system.

FIG. 2.2 shows a flowchart detailing a proposed framework.

FIG. 2.3 shows growth truth nerve slice (top) and predicted nerve mask (bottom) for POCUS Atlas image.

FIG. 2.4 shows a subset of 2D LCA sparse coding filters learned on the ONSD dataset.

FIG. 2.5 shows Table 2.1: Accuracy (over 3 runs) for the ONSD dataset.

### DETAILED DESCRIPTION OF THE EMBODIMENTS

### 1. Sparse Coding for Detection Given Limited Training Examples

### 1.1 Application Context

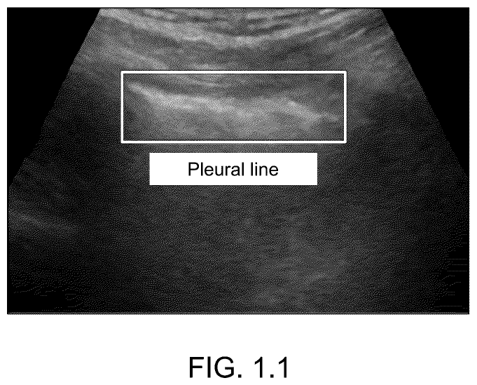

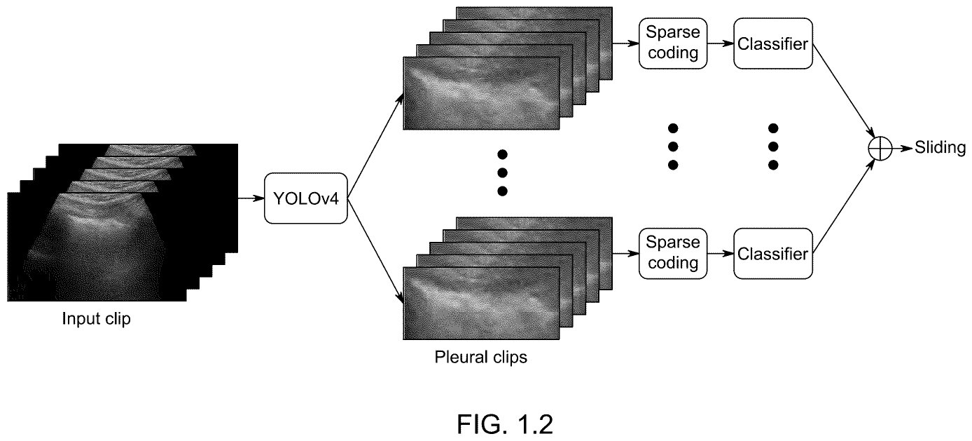

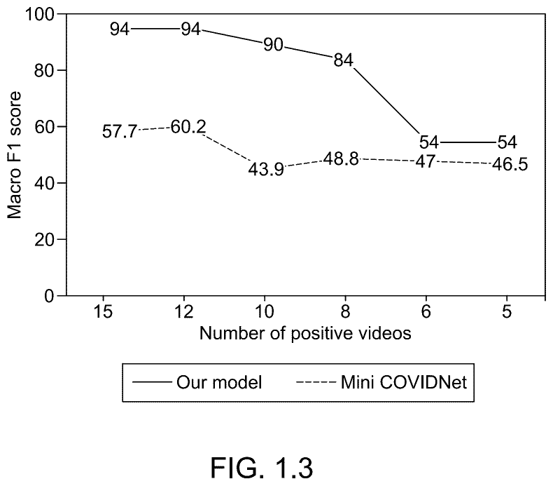

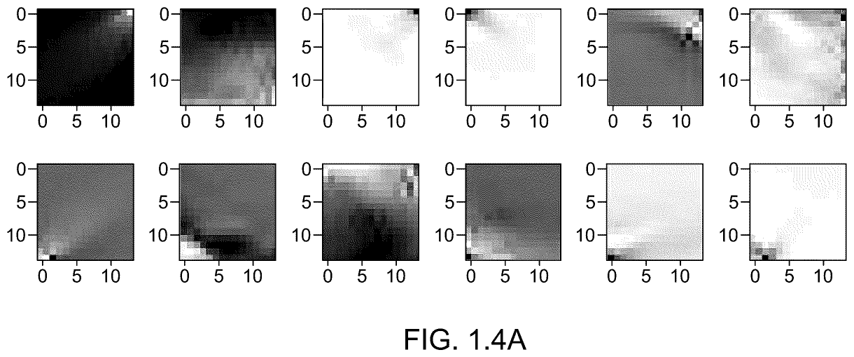

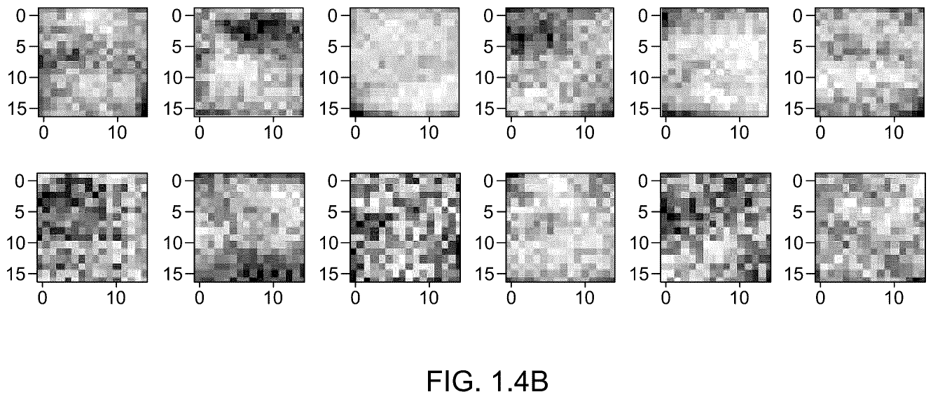

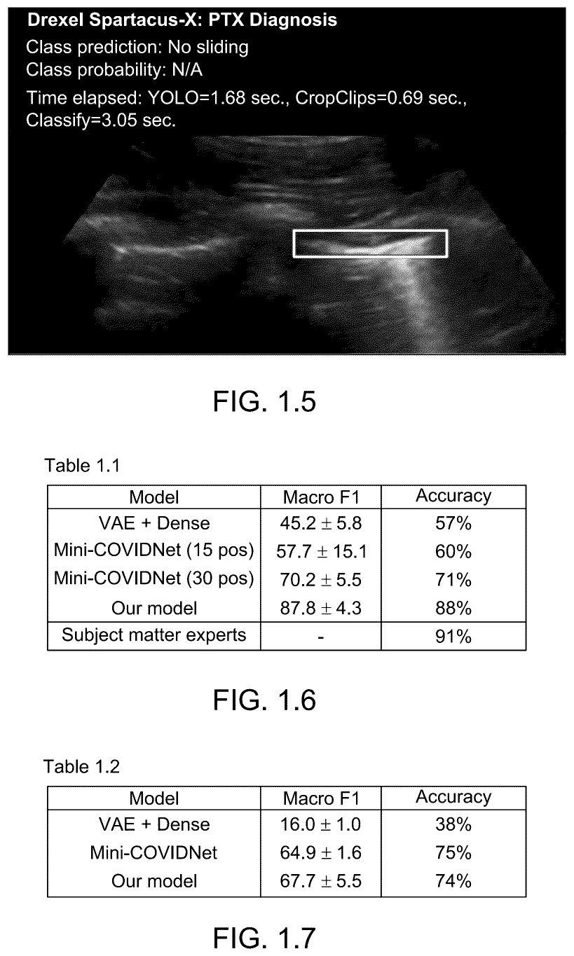

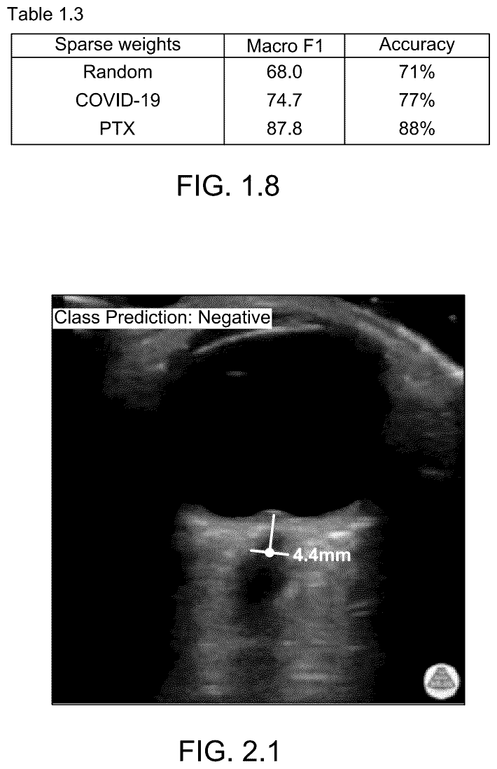

The primary task that the inventors focused on was PTX (i.e., abnormal collection of air in the pleural space between the lung and chest wall, potentially causing significant lung collapse) detection. The requirements of this task specify that an agent must analyze an ultrasound video and determine whether the patient exhibits the signs of PTX (positive) or does not exhibit the signs (negative). The primary artifact of interest is the pleural line, which is where the lung surface and chest wall make contact. This takes the form of a bright horizontal white line that extends across part of the video as shown in FIG. 1.1. In a healthy patient, one can see the visceral and parietal pleura sliding relative to each other at the pleural line during respiration, as well as pulsing in synchrony with cardiac contraction. In the case of PTX, air accumulation between the visceral and parietal pleura separates the two membranes and eliminates the sliding motion between them, as well as the cardiophasic movement at the parietal pleura. The inventors focused the inventors' model on these pleural line characteristics based on the think aloud analysis.

In constructing the models, the inventors constrained themselves based upon potential real-world use cases for PTX detection using POCUS. This includes engineering considerations such as the kind of equipment that would be needed to process videos in a wide range of settings, the amount of labeled data available to train the model, and the time it takes to get results. Many ultrasound devices support iOS, therefore the inventors developed the inventors' mobile application for this platform. The inventors explored using both an Apple ipad Pro and an iPhone 13 Pro for the inventors' experiments. The inventors also required the inventors' system to generate a prediction in less than 5 seconds after processing the video. Beyond these application considerations, the inventors also focused on making model training inexpensive by requiring as little annotated data as possible. Therefore, in the inventors' primary task, the inventors constrained themselves to just using 47 annotated LUS videos to train the inventors' system.

### 1.2 Model Description

The model that the inventors developed has three primary components: a YOLOv4 object detection model that locates the pleural line, a 3D convolutional sparse coding model that extracts meaningful representations and compresses the temporal information, and a classifier that produces a binary classification indicating whether or not the pleural line clip displays movement.

Processing the entire video using this pipeline would result in the inventors' application exceeding the inventors' allotted execution time. Therefore, the inventors developed a voting strategy where the model individually processes 4 clips from each video, then aggregates the predictions to produce the final overall video prediction. The inventors' application extracts these clips by striding over the video frames at a fixed interval (e.g., every 15 frames). At each point, the model extracts the given frame along with the two previous frames and two subsequent frames, resulting in a 5-frame clip. The YOLOv4 model processes the middle frame of this 5-frame clip and places a bounding box around the pleural line. The inventors' application applies this same box across all frames in the 5-frame clip, producing a final clip that only contains the region around the pleural line. The sparse coding model then analyzes this clip and creates a sparse representation, which it sends to the classifier to make a clip-level prediction. To get the final video prediction, the model takes the mode of the clip predictions. In the case of a tie (e.g., 2 clips are predicted as movement and 2 as no movement) the application considers the output logits as confidence values, averaging these and rounding to the closest prediction.

Sparse Coding. One way of minimizing the amount of labeled data required to train a model is to use unsupervised training techniques. Therefore, the inventors leveraged 3D convolutional sparse coding to create a sparse representation of the inventors' pleural line clips. Sparse coding relies upon biologically plausible learning techniques to learn a dictionary of convolutional filters.

The inventors used a convolutional variant of the Locally Competitive Algorithm (LCA) to compute the inventors' sparse features, following earlier work as a guide. One can think of this algorithm as an autoencoder that seeks to learn a set of filters, or dictionary elements, φ that accurately reconstruct an input video x. The encoder produces an activation map a, which the decoder then deconvolves with the filters to produce the reconstruction \hat{x}.

One can consider the encoder as a recurrent network where an internal state, or membrane potential, μ is updated at each timestep. The model trains via gradient descent to minimize the energy function:

$$E ( t ) = \frac{1}{2} {\sum }_{i = 1}^{N} {[ {x}_{i} - a ( t ) ϕ ]}^{2} + λ \vert a ( t ) \vert \qquad ( 1 )$$

where the first term is the sum of the squared error between the input and the reconstruction and the second term is the sparsity penalty. The activation map a(t) is the threshold internal state μ(t), where values less than λ are set to 0.

Earlier work shows that iteratively updating μ according to Equation 2 (where η is learning rate) minimizes the energy function in the convolutional case.

$$μ ( t + 1 ) = μ ( t ) + η ( e * Φ + a ( t ) - μ ( t ) ) \qquad ( 2 )$$

As shown in Equation 2, convolution (* operation) of the reconstruction error over the filters drives the membrane update. The number of timesteps over which μ updates is a hyperparameter that one adjusts through observation of when the objective function converges. During the computation of the activation map, the filters do not update. After the model produces the final activation map, the filters then unfreeze. The training algorithm then uses Equation 1 to compute the final loss and updates the filters using gradient descent.

Previous research has shown that sparse coding can produce robust, semantically meaningful visual features across a variety of tasks, from learning face classifiers to aligning binocular video. It is even robust to adversarial attacks without special modifications. However, due to its recurrent nature, sparse coding has a higher computational cost than a standard CNN, which places additional constraints on the inventors' hyperparameter selection.

Small Convolutional Classifier. Utilization of YOLOv4 and sparse coding allowed the inventors' classifier to have a minimal number of parameters. The model first maxpools the sparse coding activation map. Then it passes the resulting representation through a CNN consisting of 2 convolutional layers and 2 feed-forward layers with a single dropout layer with 50% dropout. The inventors trained the classifier with a binary cross-entropy loss function.

### 1.3 Experiments

### Experiments

The inventors first demonstrated that the model outperforms both a VAE baseline and Mini-COVIDNet on both the inventors' primary PTX task and an auxiliary COVID-19 LUS classification task. The inventors constructed the VAE baseline to have approximately the same architecture as the inventors' model, mimicking most of it while replacing the 3D sparse coding with standard 3D convolution. This baseline comparison demonstrates the utility of sparse coding. The inventors also present results with Mini-COVIDNet to compare to the most closely related work. The inventors report both accuracy and Macro F1 (See FIG. 1.3) score to account for imbalanced classes. The inventors performed all evaluations using patient grouping, where the inventors structured splits such that the same patient never appeared in both the inventors' training and test sets.

The inventors performed an analysis in which the inventors reduced the amount of training data by fixed intervals. The inventors demonstrate that as the amount of training data decreases, the gap between Mini-COVIDNet and the inventors' model widens. The inventors then explored the benefits of sparse coding by evaluating the inventors' model using sparse filters that were learned from a related LUS dataset. This is a form of transfer learning where a set of weights learned on one task are applied to another task, typically with some slight adjustment of the weights or additional layers that are learned on top of the transferred network. Compared to randomly initialized filters, these filters still produced increased accuracy on the inventors' PTX task, illustrating the benefits of learning sparse features on related data.

Model Implementation Details. The inventors developed the inventors' models in Keras and TensorFlow to facilitate running on the mobile device. The inventors exported the inventors' model to TensorFlow Lite, which the inventors then ran directly in the inventors' iOS app written in Swift. For the inventors' sparse coding model, the inventors updated the membrane potentials using the Adam optimizer and used SGD for the filter updates. The inventors trained with a batch size of 32, a filter learning rate of 3e-3, 48 filters of width 15, height 15, and depth 5, a stride of 1, an inner loop update of 300 iterations, a membrane potential learning rate of 0.01, a lambda of 0.05, an input clip height of 100, and an input clip width of 200, for 100 epochs. For the classifier, the inventors trained the model using Adam. At performance time, the inventors reduced the computational cost of sparse coding by using a stride of 2 and 150 inner loop updates. The inventors trained the classifier with a learning rate of 5e-4 for 25 epochs. The VAE shares many of the same hyperparameters, with the exception of the 3D convolution operation, which has 32 filters. The inventors trained all models on a single Nvidia A40. The inventors converted videos to grayscale and normalized to a mean of 0 before passing them to the inventors' sparse coding module. The inventors randomly rotated each input by up to +45° and randomly applied horizontal flips.

### 1.4 Pneumothorax

For the inventors' primary dataset, the Brooke Army Medical Center (BAMC) collected 62 LUS videos, 30 from patients with PTX (i.e., pleural line movement absent) and 32 from patients without PTX (i.e., pleural line movement present). Physicians diagnosed PTX radiographically and 3 expert reviewers confirmed the presence of lung sliding. For the inventors' sparse coding model, the inventors utilized all 62 videos, however the algorithm is unsupervised, so the inventors did not use labeled data for this stage of training. For training the inventors' classifier, DARPA challenged us to only use 15 labeled ‘No movement’ videos. The average length of these videos is approximately 3 seconds at 20 frames per second. BAMC collected all LUS videos with a convex probe at depths ranging from 4-12 cm. FIG. 1.6, Table 1.1 shows the results of the inventors' BAMC PTX experiments. The inventors' model achieved an F1 score of 87.8 on the inventors' test set and it outperformed both the inventors' VAE baseline and Mini-COVIDNet, which obtained F1 scores of 45.2 and 70.2 (30 pos), respectively. The inventors exposed the inventors' sparse coding model to all 30 positive examples (without labels), yet exposed the inventors' classifier to only 15 positive examples (with labels). Therefore, the inventors evaluated Mini-COVIDNet in both a 15-positive labeled examples setting, where it had a slight disadvantage, and a 30-positive labeled examples setting where it had a clear advantage. Two SMEs evaluated the test set and achieved 91.1% agreement, slightly outperforming the inventors' model. The inventors attribute the inventors' model's success to its emphasis on learning robust visual features despite having limited data. To further illustrate this, the inventors conducted a series of experiments in which the inventors discarded positive samples from the training set. FIG. 1.3 shows a graph depicting the results of these experiments run for both the inventors' model and Mini-COVIDNet. While Mini-COVIDNet displayed low performance with 15 and 12 positive examples, before barely outperforming chance with subsequent reduction, the inventors' sparse coding model achieved reasonable performance with just 8 examples, reaching an F1 score of 84.

### 1.5 COVID-19

The BAMC PTX Dataset is not publicly available, therefore the inventors also evaluated the inventors' model on the COVID-19 Ultrasound Dataset. This dataset contains 202 LUS videos. Each video has one of four labels: COVID-19, Regular, Bacterial Pneumonia, or Viral Pneumonia.

FIG. 1.7, Table 1.2 contains the results of the inventors' COVID-19 experiments. The inventors reevaluated Mini-COVIDNet to ensure that evaluation remained consistent across models. The inventors' model slightly outperforms Mini-COVIDNet in Macro F1 (See FIG. 1.3). MiniCOVIDNet achieved an F1 score of 64.9, while the inventors' model achieved an F1 score of 67.7. However, the accuracy of Mini-COVIDNet was slightly better than the inventors' model on average. The inventors hypothesize that comparable performance between the inventors' model and Mini-COVIDNet is observed on this task due to some differences between COVID-19 and PTX detection. Evaluation of the pleural line movement is not necessary for COVID-19 classification; individual frames frequently contain enough information to make a prediction. This lack of emphasis on the pleural line required us to remove a critical part of the inventors' pipeline, the YOLOv4 object detection, while the lack of temporal dependencies nullified some of the benefits of 3D sparse coding. To improve the inventors' model's performance on this task, expert knowledge regarding which features are most important for COVID-19 detection could be used to retrain YOLOv4, allowing them to add it back into the inventors' system.

### Analyses

Sparse Coding Filter Transfer. The inventors determined that sparse coding played a crucial role in the inventors' model's success because the VAE was virtually incapable of learning the PTX task. To better quantify the benefits of sparse coding, the inventors further evaluated the inventors' model on the PTX task using 2 different sets of sparse weights. The inventors borrowed the first set from the COVID-19 sparse coding pre-training. These weights were loosely correlated with the PTX data, as they both came from LUS videos. The inventors randomly generated the second set of weights. FIG. 1.8, Table 1.3 contains the results of these experiments and shows the PTX weights do outperform the others. This is because sparse coding can still work with random filters. The filters compete with each other to represent the data that the model sees, and the classifier can still learn to leverage these representations to make its prediction. However, important features that might be specific to the inventors' task are lost, such as filters that detect the pleural line or filters that detect movement.

Sparse Filter Visualization. The 3D sparse features are the backbone of the inventors' model. These high-quality visual features allow us to learn a lightweight classifier with minimal supervision. FIGS. 1.41 and 1.4b contain the first frame of the inventors' 5-frame filters compared with the same filters learned by the inventors' VAE baseline. The sparse coding filters illustrate Gabor-like structures; some filters are relatively static, capturing edges, while others change drastically frame-to-frame, accounting for movement. A CNN is capable of learning similar structures, however the filters in the inventors' VAE are exceptionally noisy due to the limited training dataset. In contrast, the inventors' sparse coding model extracts spatially and temporally relevant features despite being trained with few examples.

Interpretability. For interpretability of the PTX task, the inventors examined agnostic explainable AI methods to provide feature attributions. The inventors implemented kernel SHapley Additive explanations (SHAP) except that instead of using input instances, the inventors used sparse coding. SHAP is an additive feature attribution method that models the classifier as a sum of feature contributions. Its local accuracy property dictates that, for each instance, the sum is to produce the same value as the classifier. The inventors then explored whether SHAP's feature attributions could reveal filters with low importance that could be hindering classification accuracy. The inventors selected several combinations of low score filters to mask, thus preventing them from representing videos. The inventors found at least one set of five filters that when masked, caused one misclassified video to be correctly classified. When evaluating individual clips, the greatest impact was on sliding clips where out of 176 misclassified, more than 50% changed from incorrect to correct. The inventors have yet to find an efficient and consistent way to identify such filters.

iOS Implementation. Portability is a focal point of POCUS technology. However, many state-of-the-art computer vision techniques have become increasingly computationally expensive. While executing large models on a remote machine might be feasible in some scenarios, having the ability to run on a local device allows for the application to be deployed in even the most austere environments. Towards this goal, the inventors ensure that the inventors' model is capable of running within a reasonable time on a mobile device. For the inventors' experiments, the inventors selected a 12.9-inch Apple iPad Pro, a 1.57-pound device that supports most of the handheld ultrasound devices on the market. Additionally, it has the new M1 processor, a highly efficient and powerful chip that has both a neural engine and a GPU. The inventors built an iOS application using Swift that allows a user to select a list of videos to run through the inventors' model. It takes 5.83 seconds on average to execute the inventors' model on the iPad; the app replays the LUS video with YOLO bounding boxes around the detected pleural line regions (FIG. 1.5). These boxes are red or green (negative or positive, respectively) depending on the predicted class at that given point in the video. This provides feedback to the end user and enhances the interpretability of the inventors' application. The app displays the final overall prediction and shows a pop-up box that gives the user the option of exporting a CSV file containing the results.

Deployment Considerations. As the inventors prepare the inventors' application for deployment there are a number of considerations that the inventors must take into account. First, while the inventors' application focuses on facilitating diagnosis of a collected video, the collection process itself poses many challenges. In the inventors' test cases, experts analyzed the videos to ensure that they were sufficient for PTX differential diagnosis. However, when the inventors deploy the inventors' application in the field, it may encounter poor quality samples. In the short term, the inventors can make the inventors' model more robust to these cases by augmenting the inventors' training data with poor quality samples. The inventors can add these to the inventors' present classifier as a third class or feed them to an auxiliary classifier that determines if a video is of sufficient quality for the inventors' PTX classification model. In the long term, the inventors can integrate the inventors' application with other technologies that guide the collection procedure. Another aspect that the inventors must consider is explainability. These models should be used to augment care rather than replace healthcare providers and therefore a great deal of utility lies in the model's ability to report key information back to the healthcare provider. The inventors already took a step in this direction by highlighting the YOLO regions in the video after the inventors' model executes on the iPad and by beginning to investigate explainable AI methods. However, in the future the inventors plan to further improve both the model and user interface to maximize the information that healthcare providers receive.

### 1.6 Conclusion

In this work, the inventors presented an LUS video classification system. The inventors focused on developing a model in a constrained setting. Due to the high cost of labeling and collecting ultrasound video, the inventors limited the inventors' model to just a few dozen labeled training examples. Therefore, the inventors leveraged expert knowledge to construct a model pipeline that was able to achieve performance on par with human experts on a binary PTX classification task. The inventors provided a robust set of experiments analyzing the inventors' performance compared to other architectures, evaluated on two different LUS datasets, and provided a qualitative analysis of the features learned by the inventors' sparse coding model. Lastly, the inventors demonstrated that the inventors' final architecture was able to run on an iPad Pro in less than 6 seconds, and discussed additional deployment considerations that the inventors must consider as the inventors proceed with developing the inventors' application. Ultimately, the inventors hope the inventors' system will increase POCUS adoption and improve quality of care for patients.

### 2.0 Developing Interpretable Ultrasound Imaging Systems Via Subject Matter Expert (SME) Guidance

### 2.1 Framework Description

Medical imaging tasks are, by their nature, application driven. Tasks are selected because they present the opportunity to directly improve quality of care. In other domains, a task may be interesting in its own right; researchers might be interested in studying the type of knowledge or mechanisms that a model learns. In these cases, accuracy tends to be prioritized above all else, including user safety. This conflicts with the medical domain, where accuracy is just one of many important factors; other metrics such as safety, interpretability, reliability, and more, can be equally, if not more, important. For this reason, the model development cycle for medical tasks should look different than those typically employed by the research community. SMEs may be included in the discussion from the beginning, deployment constraints may be understood and consistently verified, and evaluation needs to include feedback from target users. Towards these goals, the inventors created a framework for developing interpretable machine learning models targeting ultrasound imaging tasks.

Connect with SMEs and Obtain a High Level Understanding of the Task

The first phase of the pipeline is focused on acquiring a robust understanding of the target medical condition and the role that ultrasound imaging plays in diagnosis and management. This contextualizes the task and will form the foundation for later stages of the framework. At this point, machine learning approaches may not be considered.

Understand the condition. First the underlying medical condition that necessitates the use of ultrasound imaging in the target scenario should be understood. Some key questions that need to be answered include: what is the condition, what factors are considered when making a diagnosis (beyond just imaging), what is the prognosis, and how quickly must a diagnosis be made to guide treatment? Discuss situations where the technology may be deployed and the expertise required to diagnose the condition with the diagnostic techniques in the specific settings. This may vary according to the target users, e.g., the expertise of a doctor is different than a battlefield medic. For experts, the goal may just be to improve detection for images that are difficult to interpret. For non-experts, the goal might be to perform tasks that are typically only performed by experts, i.e., if the system can highlight regions of interest that may be difficult to detect, a non-expert may then be able to easily perform subsequent tasks, such as object tracking or measurement.

Understand the indication to the test. Each time a test is performed, the inventors need to consider why the test is being performed, what the advantages, limitations and risks are to the specific test, and what the diagnostic performance characteristics are of the specific test. Moreover, in addition to the imaging component, there are often other factors that are taken into consideration when formulating the diagnosis. Understanding these other factors is critical, as they could be used to directly improve the model (as an additional input), or, at the very least, used as an additional source of verification. Additionally, the diagnostic reference standards need to be understood. In some cases, ultrasound imaging may not be considered an effective or commonly used technique for diagnosis. If this is the case, assess whether it would actually be useful to have a medical imaging application targeting this task. There may be other factors, such as deployability or cost, that make imaging viable.

Understand ultrasound acquisition and interpretation. After analyzing the target condition, diagnostic principles and indications, the process should focus on image acquisition and interpretation. The SMEs should walk through the procedure, discussing critical parts of the acquisition process. Potential issues that can be encountered during acquisition also need to be discussed. Even in clinical settings, suboptimal images are not uncommon. In other settings, such as a battlefield, these types of issues could be frequent. If the collected sonograms are poor quality, training any sort of machine learning model would be very challenging. Conversely, if the model is only exposed to near perfect examples, its robustness to noise suffers. By understanding the types of errors and rates at which they occur, the quality of the training data can be balanced.

Ultrasound interpretation follows a logical stepwise approach including: an assessment of the adequacy of the images for interpretation, establishing the presence or absence of suspected findings, generation of an ultrasonographic differential diagnosis, and procession to further scanning as needed. It is crucial to understand which anatomical structures, and non-anatomical phenomena, are most important to examine and the role that these structures play in the final diagnosis. Understand how noise is manifested in the sonograms themselves. What makes an image appropriate for diagnosis and what does the ideal image look like?

Decompose the Task into Individual Steps

This stage focuses on decomposing the task into individual steps, simplifying the target task by leveraging expert knowledge acquired in the prior stage. This allows for separate models to be applied to individual stages of the diagnosis while providing the additional benefit of increasing the interpretability of the system.

Initial decomposition. The decomposition begins with an analysis of ultrasound interpretation for the target task. This can take a more structured form, like a think-aloud study, or can be informal. Based upon this analysis, individual steps can be identified and composed to form a pipeline. These steps might include identifying objects of interest, measuring the distance between two objects, identifying whether the frame is appropriate for interpretation, etc. Each step should build upon those previous, where early steps simplify latter steps by limiting the amount of information that must be considered. Identify challenging steps in the pipeline. Keep the overall goal of the task in mind, which is augmenting care by facilitating clinical diagnosis by a healthcare professional. For this reason, it might be advantageous to adjust the pipeline based upon which parts of the diagnosis process are most difficult for human examiners. Identify what information could potentially improve the human's ability to make an informed decision and then try to structure the pipeline such that the relevant information is able to surface. Determine whether each step is feasible for a machine learning model. Identify whether each sub-task seems feasible for a machine learning model. Is the sub-task a form of classification? Object detection? Segmentation? If the task does not seem well suited for a machine learning model, it may indicate that further decomposition is required. Alternatively, steps might be able to be combined and addressed more effectively with a single model, resulting in sub-tasks being merged together. There should be as few steps as possible without making the tasks too complicated, while still ensuring that the relevant information is surfaced. This may be an iterative process of adjusting the pipeline, guided by the needs of the target users.

### Identify Model Components for Each Step of the Pipeline

This stage focuses on designing the machine learning architecture, given the proposed pipeline. Individual model choices are made for each sub-task and the interaction among these components is considered. This stage of the framework may require a lot of iteration and will frequently be returned to from stage 4.

Identify a strong starting point. To minimize iteration, selecting a strong staring point may be beneficial. Identify existing work that may have addressed similar problems. For instance, if the sub-task is a form of object detection, seek out state-of-the-art object detectors. It is possible that an off the shelf approach will get strong results on one of the sub-tasks, and, even if it does not, it will serve as a strong foundation for further development. It is worth noting that in some cases, a machine learning model may not even be necessary, or that a simple approach is sufficient for the target task. Complex models tend to be harder to train, more data intensive, and less interpretable; simplicity may be preferred.

Analyze the data. Machine learning models are data driven. Consider how much data is available for the overall task and for each sub-task. In the medical domain data is frequently limited. However, there are varying degrees of data scarcity; a few thousand examples might be sufficient for tuning a large model, whereas a few dozen examples makes both training and evaluating virtually any model challenging. Assess the quality of the data. Can the SMEs interpret the sonograms that will be used to train the models? If there are low quality examples, are they evenly distributed between classes? If there is not enough data available, or some sub-tasks need new ground truth labels, there may be additional labeling required. If acquiring additional labels is not possible, or it is too costly, return to stage 2 and reevaluate the proposed decomposition.

Determine what constitutes ground truth. In a standard machine learning task, ground truth information is considered to be the labels provided with the dataset. However, in medical imaging things are more complicated. Most tasks are focused on diagnosing a specific condition and the data that is collected for training the models will come from patients that have this target condition. It is possible that not all collected images will display the expected symptoms, leading examiners to classify them as ‘healthy’, despite actually coming from a patient with the condition. Unfortunately, using the status of the patient as the ground truth label has its own issues associated with it. If the image does not show the patterns indicating that the condition is present, the ‘unhealthy’ label will confuse the model during training. While there is not perfect solution to this problem, understanding which category the labels fall into is important for understanding the implications of the trained model's predictions and the performance upper bound.

Determine whether the selected models are compatible. Consider how the models that were selected for each sub-task fit together and how information will flow between them. The performance of prior stages tends to affect the downstream performance of latter stages. Ideally, the early stages of the pipeline will be simpler than the latter stages, gradually reducing the complexity of the final task. For instance, identifying the ocular nerve in a sonogram is easier than measuring the width of it. If an early task is too challenging, this will limit subsequent models and result in a reduction in overall accuracy.

### Train and Evaluate

The final stage of the framework focuses on training and evaluating the system. This step will be revisited repeatedly, returning to the prior step, selecting different models, and based upon the results, making adjustments.

Train and evaluate each model. Each model should be trained and tuned in isolation from one another. It may be tempting to make certain adjustments to one model based upon observations in others, but this can complicate the training process and result in converging on a suboptimal solution. During training, utilize ground truth wherever it is available in the pipeline. Including noisy predicted data in the training pipeline will only result in decreased performance. Each sub-task should have its own evaluation metrics, both automatic and qualitative. Have SMEs analyze the predictions and identify various kinds of errors that are being made. Do humans make the same kinds of mistakes that the model is making? Determine whether it seems the low performance is due to model choice, data issues, or whether the task is just ill-defined, and return to the appropriate step to make the necessary adjustments.

Analyze the entire pipeline. After optimizing each subtask the entire pipeline should be evaluated. Identify weak points by observing the performance of each model and considering how it propagates to the final prediction. Ask more broadly whether each model served its role appropriately. This includes whether it was able to surface information that could help target users. Lastly, consider whether the SMEs find the application useful. Are there additional proposed modifications now that they have a working prototype? After answering these questions return to prior steps of the framework to make adjustments to the individual models or to the overall pipeline.

Talk to end-users. Once the application has reached a reasonable point, likely after multiple iterations through the framework, get it into the hands of the target users. Do not do this too early; if the application is not performing well it will be hard to see its utility. Ask if they find the predictions and visualizations useful. Ask whether there is additional desired functionality. This feedback should be taken seriously as these will be the individuals that will ultimately benefit from the application. Using this feedback, once again return to prior stages of the framework.

### 2.2 Optic Nerve Sheath Diameter (ONSD) Measurement Application

This section focuses on applying the proposed framework to the task of ONSD measurement. To avoid belaboring each point, the inventors do not individually walk through each stage of the framework. Rather, the inventors provide an overview of the task, including key insights provided by the SMEs, discuss how the inventors decomposed it, and share how the inventors converged on two different systems.

A high level understanding of ONSD measurement. Timely and accurate detection of elevated intracranial pressure (ICP) is crucial in diagnosing and managing various neurological conditions, including traumatic head injury (TBI), hydrocephalus, post-cardiac arrest encephalopathy, and intracranial hemorrhage. In the past, invasive ICP monitoring was the sole effective method for detecting elevated ICP. However, this approach necessitates neurosurgical intervention and is associated with significant complications. Moreover, it is not feasible in resource-limited settings, such as remote areas, pre-hospital settings, and facilities without neurosurgical capabilities. Therefore, there is a need for noninvasive ICP monitoring methods that can facilitate early diagnosis and management of patients with acute brain injury while preventing complications.

The optic nerve, which is located posteriorly to the retina, can be considered an extension of the brain and is surrounded by the meninges, which are collectively known as the optic nerve sheath (ONS). Changes in intracranial pressure are transmitted to the ONS, resulting in corresponding fluctuations in its diameter. Studies have shown that the most responsive and sensitive portion of the optic nerve to ICP changes is the bulbous section, located approximately 3 mm posterior to the ocular globe. By utilizing imaging technologies, it is possible to measure the optic nerve sheath diameter (ONSD) at this level, offering a non-invasive approach to detect elevated ICP. Ultrasound holds advantages over other imaging techniques as it can be easily performed at the point-of-care, provides real-time results, is radiation free, and is cost-effective. Several studies have demonstrated a significant correlation between ONSD measurements obtained via ultrasound and invasive ICP measurements

Acquisition of sonographic images of the ONS can be challenging because the probe needs to be positioned correctly for the nerve and its sheath to be acceptable for measurement. A partially visible nerve and sheath can result in an inaccurate measurement, potentially misdiagnosing the patient. The examiner typically will collect a video, trying to get the nerve into focus by performing small adjustment movements in several directions. Once a video containing a properly imaged optic nerve and its sheath has been collected, its careful review will determine which frame(s) demonstrate the OSND and display it accurately for measurement. At this point, a plane located 3 mm posterior to the ocular globe will be identified, specifically targeting the bulbous section of the optic nerve. The objective is to measure the distance of decreased echogenicity between the clearly visible hyperechoic demarcations of the nerve sheath. Various published studies have explored the identification of elevated ICP, often using a cutoff value of 5 mm. However, it's worth noting that varying cutoff values have been reported, ranging from less than 5 mm to greater than 6 mm, corresponding to elevations of ICP greater than 20 mm Hg.

ONSD measurement task decomposition. Walking through the steps with the SMEs, the inventors identified a few critical parts of image interpretation. First you must identify both the nerve its sheath, and the eye, with its anterior and posterior chambers and the lens, to avoid obliquing the image. Ideally, the ONS will be entirely visible. This means that it has clearly defined boundaries and that it can clearly be seen reaching the posterior part of the ocular globe (i.e., retinal plane). However, if the nerve is not entirely visible throughout the entire video, a decision must be made to select the best frame. Once the frame is selected, the examiner must determine the angle that the nerve enters the eye. The final measurement will need to be taken perpendicular to this angle. The examiner measures 3 mm from the retinal plane, towards the center of the nerve and takes the measurement at the determined location and angle.

2D convolutional sparse coding. The inventors propose two models for this task, identifying components that closely follow the diagnostic procedure. When considering each of the stages, some additional labels may be required to identify the ocular globe, directly predict the width of the ONS, etc. However, labeling data is time consuming and it was not feasible to label every frame in the video. Therefore, the inventors first approach attempted to minimize the amount of labeling that was needed. The inventors collected an additional 220 labels in the form of bounding boxes around the nerve in some frames. They then trained a YOLOv5 model to identify the nerve. This step facilitates diagnosis in multiple ways. First, by extracting the nerve and its sheath, it reduces the input that the inventors are passing to subsequent stages of the model. Second, it also allows us to visualize the predicted bounding box for the examiner, increasing the interpretability of the model. Third, it can serve as a means of filtering frames that are unfit for measurement because the YOLO model was trained on high quality frames and will be less likely to detect nerves that are only partially visible. The inventors then sparse code the extracted nerve region using a 2D convolutional variant of the LCA sparse coding algorithm. This is a biologically-inspired unsupervised algorithm that is capable of learning a robust set of features given only limited examples. This model is trained on the entire frame, not just the extracted nerve region. After applying sparse coding, the inventors trained a small convolutional classifier on a binary prediction task, corresponding to whether or not the nerve sheath is over the 5 mm threshold. To make a video level prediction, the inventors stride over frames in the video using a fixed interval, get predictions for each frame, average them, and round the result.

U-Net width prediction. To improve upon the sparse coding approach, the inventors further decompose the task after object detection, with the goal of increasing the accuracy and interpretability of the model despite additional labeling being required. The inventors collected bounding boxes for the ocular globe and retrained the YOLOv5 model to identify both the ocular globe and ONS. The pipeline then undergoes a number of steps without any machine learning. A line is drawn between the center of the ONS and the center of the ocular globe, determining the angle of measurement. The inventors measure a point, on this line, that is 3 mm from the retinal plane. The inventors crop a 16×128 region that is centered on this point and adjusted to the angle that the inventors calculated previously. The inventors then use a R2UNet model (Alom et al. 2018) to predict a mask that covers the nerve in this region. The inventors use this mask to directly measure the distance between the predicted boundaries of the ONS at the measurement point. The R2U-Net model is trained on 224 masks that an author of the paper labeled. These frames were then further curated by discarding any masks that led to a measurement that conflicted with the final video-level label. While the model is only trained on this subset of frames, the inventors use it for video prediction for all available videos, where the procedure is run at fixed intervals over the course of the video, the widths are averaged, and the final video-level prediction is made according to whether the average width exceeds a fixed threshold.

### 2.3 Experiments and Results

The inventors present results on an ONSD video classification task, comparing to two baselines: CLIP VIT-B/16 and ConvNeXT that represent out of-the-box foundation model approaches using transformers and convolutional networks, respectively. CLIP is pretrained on the original dataset described herein. The ground truth image is encoded by the pre-trained model, then passed to a 2 layer ANN classifier. The ConvNEXT model is pre-trained on ImageNet-1k. After encoding the image, the last layer of the model is pooled and is similarly passed to a fine-tuned 2 layer ANN classifier.

### Experimental Setup

The inventors train the models on an ONSD dataset that was collected by an independent group of SMEs. This dataset contains 61 videos (22 positive and 39 negative) that are, on average, 15.3 seconds long. Two physicians with expertise in ONSD measurement with ultrasound analyzed each video, determined which frame in the video should be measured, and measured the width of the ONS. If the width of the ONS was larger than 5 mm, then the video was classified as ‘positive’, indicating the potential presence of elevated ICP. If the width was less than 5 mm, then the video is classified as ‘negative’, indicating that it is unlikely the ICP is elevated.

With the additional labeling that the inventors performed for training the R2U-Net system, the inventors were able to identify high-quality frames in the dataset. The inventors trained the sparse coding model on just this subset of data as well and found that it performed better than when the model was trained on all of the available frames. Therefore, this subset is used for all model training, but evaluation is done on frames sampled at a fixed interval from each video in the test set. All models are evaluated using 10-fold evaluation and participant grouping, where there is no patient overlap between the training and test sets.

The R2U-Net model was trained for 500 epochs with the Adam optimizer and a learning rate of 0.0001. It has 2 up-conv layers, 2 down-conv, and 2 recurrent layers. It is trained with batch norm, max pooling, bilinear unpooling, and ReLU activation functions. The inventors manually set a cut-off value for positive/negative width of 46 pixels (slightly more than 5 mm) based upon the initial training dataset. It was implemented using Sha (2021) and was trained on a single Nvidia A40 GPU. The sparse coding model was trained on the same hardware with a batch size of 32 for 20 epochs. The inventors used 32 15×15 convolutional filters and updated them using stochastic gradient decent with a learning rate of 0.005. The activation map (inner loop update) was computed over 300 timesteps and was updated using the Adam optimizer with a learning rate of 0.01 and sparsity parameter of 0.05. The baselines were trained with Adam using a learning rate of 0.00005 for CLIP and 0.0005 for ConvNeXT with hidden layer sizes of 100 and 20 for 20 epochs. Our approaches to the task were tuned on a subset of the data, prior to the release of an unseen test set. Once the inventors acquired this second set of data, the inventors mixed it and adopted the k-fold evaluation strategy. The baselines that the inventors compare against, were instead tuned directly using the k-fold strategy, resulting in potential data leakage that would have only benefited the baselines that the inventors compare against.

### Results

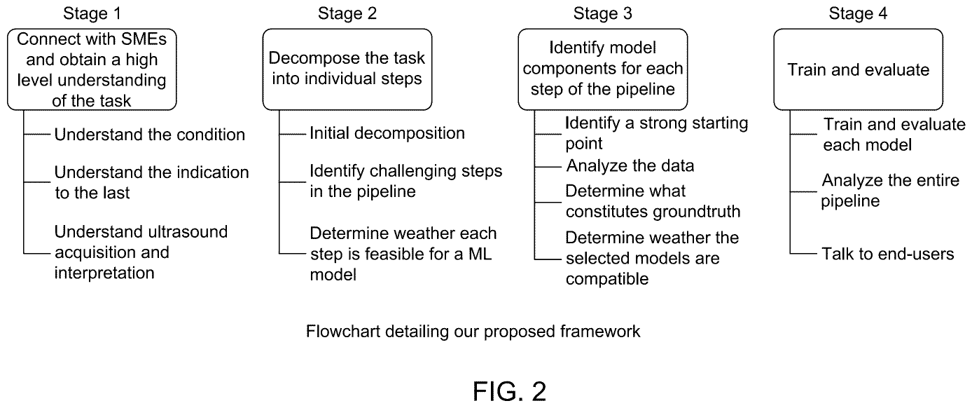

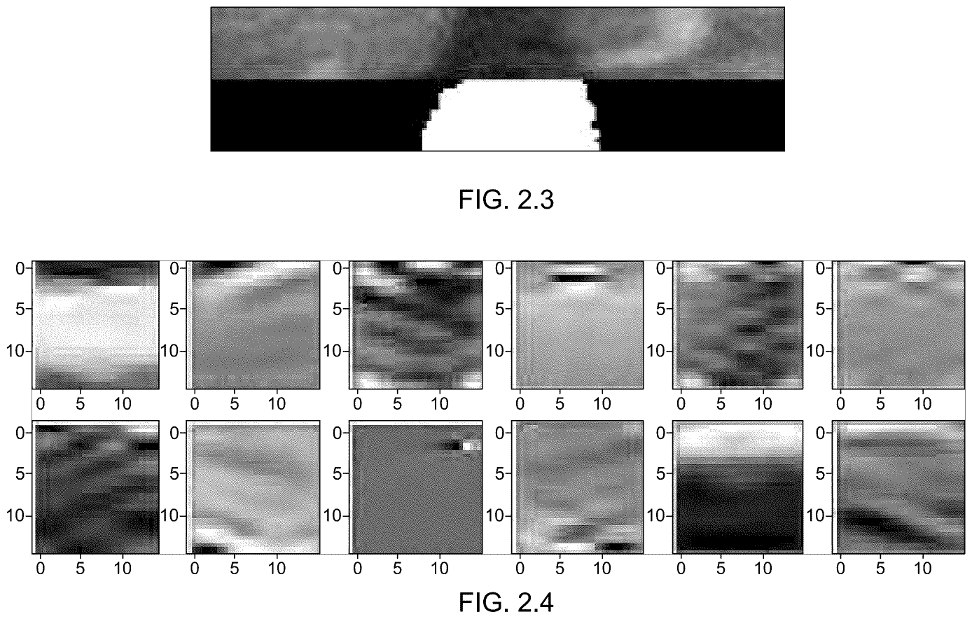

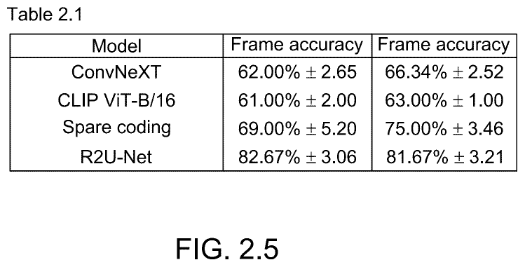

FIG. 2.5, Table 2.1 contains the results of the experiments. Our proposed R2U-Net architecture obtains 82.67% accuracy on the video classification task while the sparse coding model obtains 69% video accuracy. This gap in performance illustrates the benefits of further task decomposition, even at the cost of additional labeling. Additionally, it demonstrates the importance of applying the proposed pipeline to each target task. The sparse coding approach shares a similar structure to Hannan et al., which was developed for pneumothorax detection. By applying the framework, the inventors were able to identify the shortcomings of the model and develop the R2U-Net system. The ConvNEXT model and the ViTB/16 model only obtain 62% and 61%, respectively. This illustrates that despite the models being pre-trained on large datasets, fine-tuning them on a small medical dataset is challenging; they are not well suited for the task out of the box. The inventors conduct additional evaluation on the various stages of the pipeline. For YOLOv5, the inventors held out 20 frames for evaluation and found that the mean average precision for predicting both the ocular globe and the optic nerve was 99.5%. For the U-Net model the mean average error for the predicted width is 1.04 mm. A visualization of a predicted R2U-Net mask can be seen in FIG. 2.3.

In addition to these automated evaluation metrics, the inventors also had one of the SMEs qualitatively assess a random assortment of 20 test images with predicted labels, similar to FIG. 2.1. The inventors discarded 5 examples that the SME was unable to interpret, leaving 15 images in total. For each example, the SME was tasked with providing a binary response to 2 questions: “Does the predicted angle correctly correspond to the angle of the nerve?” and “Does the predicted width correctly correspond to the width of the nerve at the measurement location?”. For the first question, the SME answered ‘yes’ for 13/15 of the images, indicating that the model is able to correctly predict the angle in 87% of the generated cases. For the second question, the SME answered ‘yes’ for 12/15 of the images, indicating that the model correctly predicts the width in 80% of the generated images.

Interpretability Interpretability is fundamental to the proposed framework and systems. Traditional post-hoc gradient-based explainability techniques and specialized model components may yield some insights into a model, but their predictions can be hard for the target user to interpret. For instance, the filters learned by the sparse coding model (FIG. 2.4) falls into the latter category. These filters display gabor-like structures which directly correspond to task-specific visual features. While this can provide interesting insights into the features that the model is using to make the final prediction, the inventors did not find this to be the case for the task. The inventors attempted use these filters to generate an attention map based upon their activity levels, however, this did not display any meaningful semantic information. While specific tuning for this functionality may have produced different results, this would only highlight the fragility of these approaches, which are dependent upon the specific model's weights.

The approach of surfacing relevant information at intermediate states in the model pipeline and structuring the pipeline according to the procedure that human experts use for interpretation, results in visualizations that are easily understood by the target user. Furthermore, they are not dependent on the specific weights of the model. A screenshot illustrating the data that surfaces from R2U-Net system can be seen in FIG. 2,1. A blue line extends from the posterior aspect of the ocular globe to the 3 mm mark in the nerve, while also indicating the angle in which the optic nerve approaches the retinal plane, the red dot indicates the point of measurement, and the orange line corresponds to the predicted width. These artifacts accurately represent the actual values that the model is using to make its prediction, rather than some approximation generated by a post hoc method. The information provided by the system can serve many different purposes depending on the target user. If the user is an expert, it may speed up image interpretation. Instead of performing the task from scratch, the expert can instead verify whether the model predictions are correct. If the user is a non-expert, such as a battlefield medic, it may fill gaps in their understanding and enable them to successfully perform a measurement they would otherwise be unable to perform.

### 2.4 Conclusion and Future Work

The inventors presented a framework for developing ultrasound imaging applications. The inventors highlighted the advantages that result from applying this framework, including improved accuracy with limited data and increased interpretability. The inventors applied this framework to an ONSD video classification task, leading to the development of two models, and provided detailed experiments demonstrating the framework's effectiveness. In future work, the inventors plan to expand this framework to other tasks, moving beyond ultrasound and generalizing to include other medical imaging devices. Additionally, the inventors hope to explore how to implement human feedback into the proposed systems/framework and apply these to additional ONSD datasets.

While the invention has been described with reference to the embodiments above, a person of ordinary skill in the art would understand that various changes or modifications may be made thereto without departing from the scope of the claims.

We claim:

1. A system for assisting in diagnosing a medical condition by classifying the medical condition comprising:
a processor that analyzes a digital image and extracts a portion of the digital image relevant to a medical condition;
a processor that uses a 3D sparse coding model to extract a sparse representation of the portion of the digital image relevant to the medical condition, wherein the sparse coding representation comprises biologically inspired mechanisms resulting in representations with orthogonal features;
a small neural network classifier that classifies the medical condition based on the sparse coding representations.

2. The system of claim 1, wherein the digital image is a lung ultrasound video.

3. The system of claim 2, wherein the portion of the video relevant to the condition is a pleural line.

4. The system of claim 3, wherein the pleural line shows lung sliding and lung pulse.

5. The system of claim 4, wherein the medical condition is pneumothorax.

6. The system of claim 1, wherein the system runs on a mobile device and the processor is on the mobile device.

7. The system of claim 1, wherein the digital image is a video, and the 3D sparse coding comprises extracting frames of the video at a predetermined interval to create sparse representations.

8. The system of claim 7, wherein the extracting of the frames comprises extracting a frame with a number of prior and subsequent frames and placing a boundary box around a middle of the frame, wherein the sparse representation is an accumulation of frames within the boundary box.

9. The system of claim 8, where in the number of both prior and subsequent frames is two.

10. The system of claim 1, wherein the extraction of the sparse representation is done using YOLOv4.

11. A method for assisting in diagnosing a medical condition by classifying the medical condition comprising:
analyzing a digital image and extracts a portion of the digital image relevant to a medical condition;
using a 3D sparse coding model to extract a sparse representation of the portion of the digital image relevant to the medical condition, wherein the sparse coding representation comprises biologically inspired mechanisms resulting in representations with orthogonal features;
classifying the medical condition based on the sparse coding representations using a small neural network classifier. The system of claim 1, wherein the digital image is a lung ultrasound video.

12. The method of claim 11, wherein the digital image is a lung ultrasound video.

13. The method of claim 12, wherein the portion of the video relevant to the condition is a pleural line.

14. The method of claim 13, wherein the pleural line shows lung sliding and lung pulse.

15. The method of claim 14, wherein the medical condition is pneumothorax.
